(19) United States
(12) Patent Application Publication
(10) Pub. No.: US 2015/0362959 A1
(43) Pub. Date: Dec. 17, 2015

(54) Touch Screen with Unintended Input Prevention

(71) Applicant: HEWLETT-PACKARD DEVELOPMENT COMPANY, L.P., Houston, TX (US)

(72) Inventor: Valentin Popescu, Houston, TX (US)

(21) Appl. No.: 14/764,742

(22) PCT Filed: Jan. 31, 2013
(86) PCT No.: PCT/US13/24021

§ 371 Date: Jul. 30, 2015

(51) Int. Cl. G06F 1/16; G06F 3/0488; G06F 3/041

(52) U.S. Cl. CPC G06F 1/1684; G06F 3/0416; G06F 3/0488; G06F 2203/04804

(57) ABSTRACT

Embodiments provide mechanisms detecting user contact with a computing device. The computing device may include a touch screen that substantially spans a surface of the computing device. In response to the detection of user contact, the computing device may prevent unintended user input within a predetermined area of the touch screen.

### BACKGROUND

Portable computing devices such as tablets, slates, mobile devices, and smart phones, among others may include touch sensitive surfaces such as capacitive or pressure sensitive displays. The touch sensitive surfaces are generally mounted within a housing containing electronic components. The housing enables a user to hold the computing device and interact with content displayed via the touch sensitive display.

### BRIEF DESCRIPTION OF THE DRAWINGS

FIG. 1 is a plane view of a computing device in accordance with an example of the present disclosure;

FIG. 2 is another plane view of a computing device in accordance with an example of the present disclosure;

FIGS. 3A-C illustrate various images of one example of unintended user input prevention in accordance with the present disclosure;

FIGS. 4A-C illustrate various images of another example of unintended user input prevention in accordance with the present disclosure; and

FIGS. 5-7 illustrate flow diagrams in accordance with various examples of the present disclosure.

### DETAILED DESCRIPTION

Portable computing devices such as tablets and slate computers, among others, are generally designed with a fairly thick frame around a periphery of the display that allows a user to hold the device without unintentionally activating user interface elements. These thick frames or bezels are generally included due to the size weight of the computing device. As the size and weight of the devices are increased, the ability to effectively handle the device utilizing only the frame becomes untenable. The frames enable a user to more effectively hold the device, and in some instance may add basic functionality, but they generally detract from the usable space of the tablet. In addition, the framing prevents the development of different aesthetic architectures for the devices, such as the development of a thin-frame tablet or a no-frame tablet.

In the present disclosure, a mechanism for selectively introducing virtual framing or touch insensitive areas to a portable computing device is disclosed. The virtual framing or touch insensitive area may enable a user to contact or hold the portable computing device during normal operation, while preventing unintentional user inputs from altering or interacting with the content displayed via the touch screen. In response to detecting a release of the contact, the computing device may alter the touch insensitive area or stop virtual framing, and thereby enable the computing device to be utilized without borders or very thin boarders. A user may be able to operate the tablet as expected without unintentional interactions and enjoy frameless videos or other multimedia once the tablet is placed on a stand or on a table.

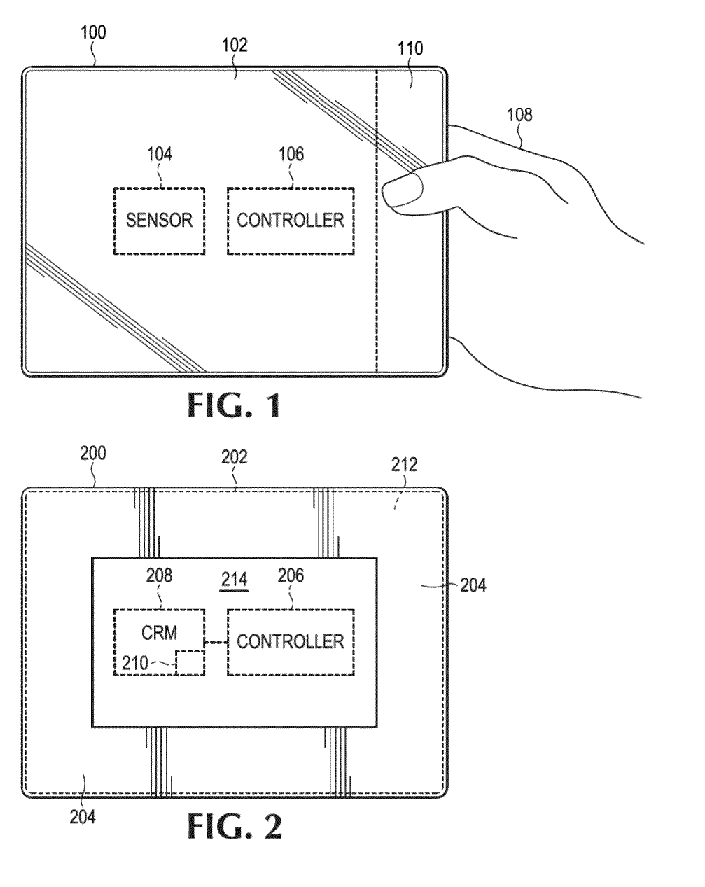

Referring to FIG. 1, an illustration of a computing device in accordance with an example of the present disclosure is illustrated. The computing device 100 comprises a touch screen 102 that substantially spans a surface of the computing device 100, a sensor 104, and a controller 106. The sensor 104 and controller 106 are illustrated in dashed lines to illustrate a possible location behind the touch screen 102. As illustrated, a user 108 is holding the computing device 100.

The touch screen 102 is an electronic visual display that a user can control through simple or multi-touch gestures. The touch screen 102 may enable a user to interact with content displayed via the computing device 100 without the need for various peripheral devices such as a mouse, touchpad, or keyboard. The touch screen 102 may be a resistive touch screen, a capacitive touch screen, or any other type of touch screen. The touch screen 102 substantially spans a surface of the computing device 100, wherein substantially spanning is defined as providing a user a perception that the tablet does not include a frame or bezel. In one example, the touch screen 102 may span the entire surface, but for a 1-2 mm bezel.

The sensor 104 may be coupled to the touch screen 102. The sensor 104 is independent of the touch screen 102 and is to detect user contact with the computing device. User contact as used herein denotes a user handling the computing device 100. The sensor 104 may be one of multiple types of sensors including, but not limited to, a capacitive sensor, a resistive sensor, or a mechanical sensor such as a pressure sensor. The sensor 104 may be disposed in one or more locations such that when a user contacts the computing device 100 in one of a plurality of areas the sensor 104 is able to readily detect the contact. Various locations will be discussed in more detail throughout this disclosure, but these locations may include the entire backside or underside of the computing device 100, a location along the periphery of one or more edges of the computing device, or along a height or width of the computing device.

The controller 106 may be a general purpose processor configured to process instructions stored on a computer readable medium, an application specific integrated circuit (“ASIC”), or a programmable logic device (“PLD”) among others. The controller 106 is coupled to the sensor 104 and is to respond to the detection of the user contact 108. The response, in various examples, may include prevention of an action associated with an unintended user input. The unintended user input may be within a predetermined area 110 of the touch screen 102. As used herein, an unintended user input is an input received by the computing device for a purpose other than that received by the computing device. For example, one unintended user input would be user interaction with content displayed by the touch screen 102 by a hand or contact intended merely to hold the computing device 100.

Referring to FIG. 2 another view of a computing device is illustrated in accordance with an example of the present disclosure. The view of the computing device 200 illustrates an example of sensor placement relative to the touch screen display 202. In the illustration, the computing device 200 includes a touch screen 202 illustrated in dashed lines indicating its placement on an opposing side of the computing device 200, a sensor 204, a controller 206, and non-transitory computer readable medium 208 having a plurality of programming instructions 210 stored thereon.

Similar to FIG. 1, the touch screen 202 is an electronic visual display that a user can control through simple or multi-touch gestures. The touch screen 202 may enable a user to interact with content displayed via the computing device 200 without the need for various peripheral devices such as a mouse, touchpad, or keyboard. The touch screen 202 may be a resistive touch screen, a capacitive touch screen, or any other type of touch screen. The touch screen may substantially span the entire surface 212 of the computing device, and therefore, may enable receipt of user inputs on substantially the entire surface 212.

The sensor 204, as illustrated, is disposed in a frame-like manner around the periphery of a backside 214 of the computing device 200. As previously mentioned, the sensor may be one of multiple types of sensors including, but not limited to, a capacitive sensor, a resistive sensor, or a mechanical sensor. The width of the sensor may be determined based upon various characteristics such as an average size of a consumer's hand, or the average positioning of a user's thumb relative to contact points on the backside of the computing device. In various examples, the sensor may extend across an entire backside 214 of the computing device. In the illustrated example a central portion of the backside 214 does not include a sensor. This may enable placement of the computing device on a lap or other body part without indicating a user is holding the device 200.

The controller 206, as illustrated, may be a processor that is configured to retrieve and execute instructions 210 from the non-transitory computer readable medium 208. In various examples, the programming instructions may cause the computing device 200 to determine that a user is holding the computing device 200 via an edge sensor 204. In response to the determination, the programming instructions may further cause the device to prevent user interaction with content displayed within a predefined area of the touch screen 202. For example, unintended user input within an area similar to 110 of FIG. 1 may be prevented.

In addition to detecting that a user is holding the computing device, the programming instructions may also determine that a user is no longer holding the computing device via the edge sensor. Such a determination may comprise the subsequent lack of detection via the sensor 204. In response, the programming instructions may enable the user interaction with content displayed with the predefined area of the touch screen that previously prevented unintended user input.

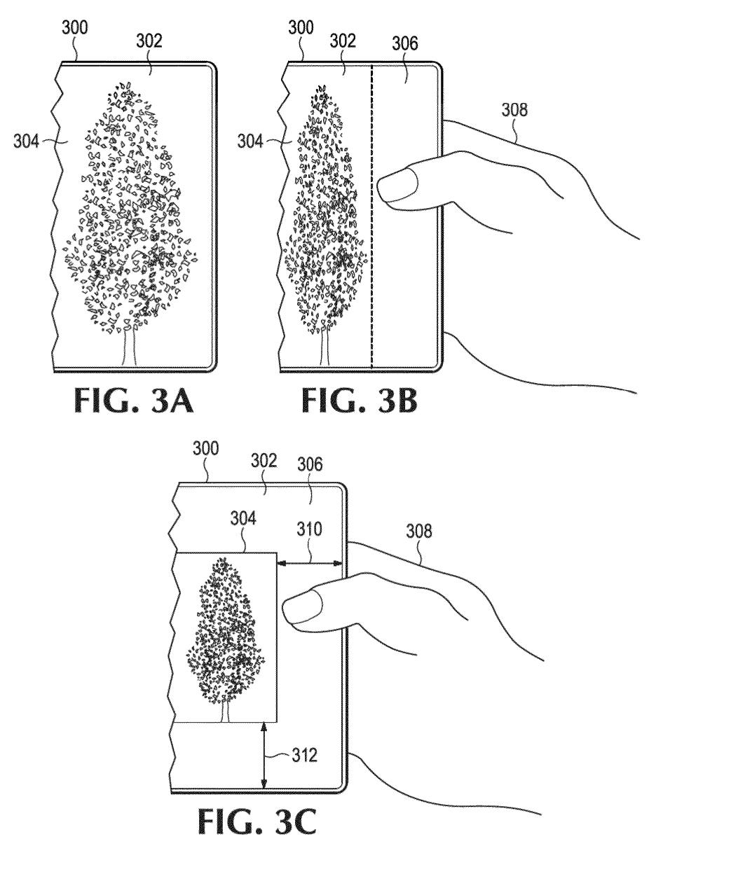

FIGS. 3A-C illustrate images of one example of unintended user input prevention in accordance with the present disclosure. For simplicity, the images will be discussed with reference to computing devices similar to those illustrated in FIGS. 1 and 2.

In FIG. 3A, an image 304 is displayed via a touch screen 302 that substantially spans a surface of the computing device 300. In FIG. 3A, a sensor (not illustrated) similar to sensor 104 and 204 of FIGS. 1 and 2, is detecting a lack of user contact with the computing device. Consequently, user interaction is uninhibited across substantially the entirety of the touch screen 302.

Referring to FIG. 3B, a similar device is illustrated. In the Figure a user hand 308 is illustrated grasping or contacting the computing device 300. The grasping may be determined via the sensor (not illustrated) that may be disposed on an edge or back portion of the computing device 300. In response to the detecting, a controller (not illustrated), which may be similar to those discussed with reference to FIGS. 1 and 2, may scale the content 304 displayed via the touch screen 302 to generate a virtual border 306 to prevent the unintended user input that may occur by the grasp or contacting of the users hand 308. The edge which is altered to include the virtual border may be determined based on input received from the sensor.

As illustrated in FIG. 3B, a single virtual border is output via the display 302. The virtual border 306 may be considered a dead-zone which includes no user selectable content. Because the virtual border is included on one edge, the image may become slightly distorted. The distortion may be accounted for utilizing various digital signal processing techniques.

In another example, illustrated in FIG. 3C, the image or content may be adjusted such that the virtual border is included on all edges of the computing device 300. The virtual border, as illustrated in FIG. 3C includes a width 310 on two edges of the device 300 and a height 312 on two edges of the device 300. It is noted that the widths and heights can be predetermined based on various criteria including the size and resolution of the images or content, any pre-programmed application capabilities, based on operating system (“OS”) capabilities, or to prevent or reduce image/content distortion. The inclusion of a virtual border on all edges of the computing device 300 may facilitate a reduction in distortion due to the constant scaling that may be utilized within the application.

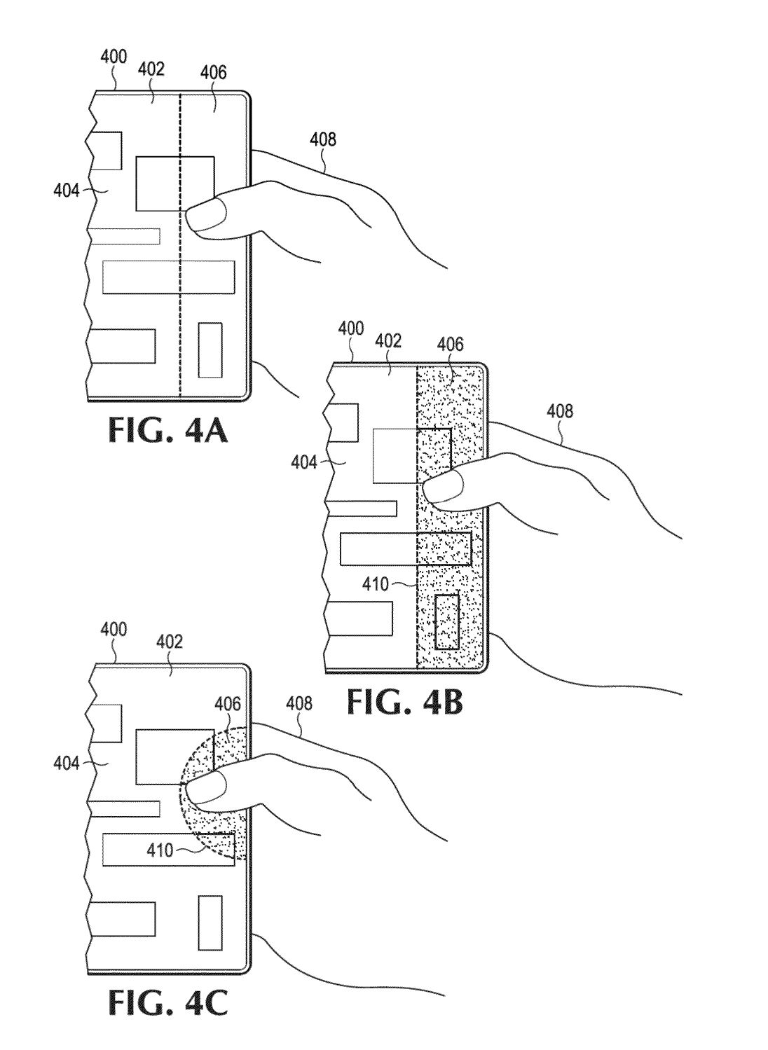

Referring to FIGS. 4A-C, various images of another example of unintended user input prevention in accordance with the present disclosure are illustrated. Again, for simplicity, the images will be discussed with reference to computing devices similar to those illustrated in FIGS. 1 and 2.

In FIG. 4A, a computing device 400 is illustrated within the hand of a user 408. The computing device 400 includes a touch screen 402, which is displaying content such as an application or user interface (“UI”). The touch screen 402 substantially spans the surface of the computing device such that no frame or bezel is available for a user to grasp the device without unintentionally contacting the touch screen 402.

In the illustrated example, a sensor may detect the hand of the user 408 and in turn, a controller may respond to the detection and prevent an action associated with the unintended user input. In FIG. 4A, the controller may merely ignore the unintended user input within a predetermined area 406. In other words, the controller may determine, via a sensor, that a user 408 is grasping the computing device 400. Rather than modifying the content to include virtual borders as discussed previously, the controller may be configured merely to disregard the contact of the hand 408. In this manner, the content may remain viewable as originally intended.

Referring to FIG. 4B, another example is illustrated in accordance with the present disclosure. In response to detection of a hand 408, the controller may generate a semi-transparent overlay to display via the touch screen. In various examples the semi-transparent overlay may cover the content or media displayed via the touch screen and convey a touch insensitive area to a user. A semi-transparent overlay, as used herein may be understood as a semi-transparent area which enables the underlying content to be viewed through the overlay. Thus a user would understand that while holding the computing device, any interaction within the semi-transparent overlay will not convey an action to the computing device. In various examples, the semi-transparent overlay may be on one side of the computing device in which the sensor has determined is closest to the hand, or alternatively, may be displayed on all edges of the computing device via touch screen.

Referring to FIG. 4C, another example of an overlay is illustrated. In FIG. 4C, a semi-circular overlay is positioned proximate to where the sensor has determined the hand is positioned. The semi-circular semi-transparent overlay 410 may prevent an unintended user interaction from a user's hand while still enabling interaction with content generally adjacent to the edge of the touch sensitive display. In various examples, the semi-transparent, semi-circular overlay may be adjusted to follow contact of the user should the contact migrate in any particular direction. While FIG. 4C illustrates a semi-circular overlay, it is contemplated that other shapes of overlays may be utilized without deviating from the scope of the disclosure.

In various other examples, existing sensors may be utilized in conjunction with those describe herein to better define locations for overlays and touch-insensitive areas. For example, accelerometers and gyroscopes may be utilized to determine whether the computing device is being held in a reading position, where it is relatively parallel to the ground, or whether the computing device is being carried with is edge generally perpendicular to the ground. In either scenario, the existing sensors may provide additional data on where to place the touch-insensitive area or the virtual framing.

In another example, other algorithms may be utilized to determine areas for overlays. For example, on a touch screen which detects multiple points of contact, a sensor on the back of the computing device may determine that one grouping of contacts is associated with unintended user input. The computing device, via for example the controller, may determine a midpoint and then determine each adjacent pixel that is detecting contact. Once determined an overlay or touch-insensitive area may be generated and displayed via the touch screen. Other algorithms are contemplated.

While a sensor may detect the presence of a hand, the sensor may conversely detect the subsequent absence of a hand, for example when the user puts the computing device within a stand or on a table. In such instances, the computing device may perform various functions to enable user interaction along the periphery of the touch sensitive device. In various examples, for example those of FIGS. 3B-C, the controller may scale the content to remove virtual borders in response to the detected subsequent absence of the user contact. In other examples, such as those of FIGS. 4A-C, the controller may remove the semi-transparent overlay or being processing any actions received within the previously predefined area.

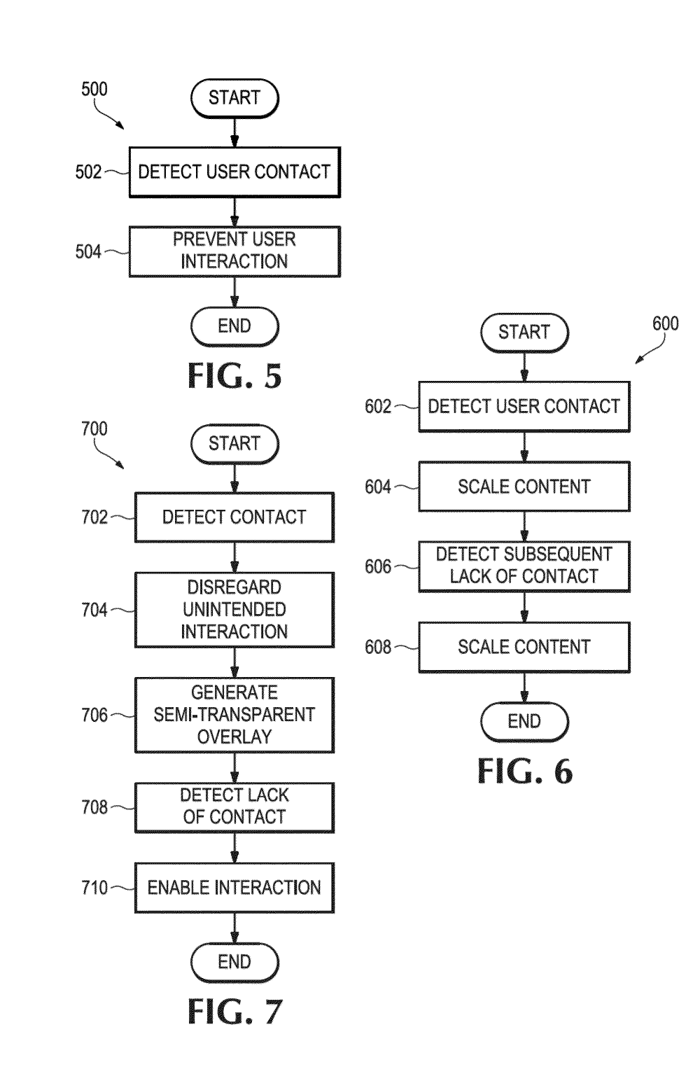

Referring to FIGS. 5-7 various flow diagrams are illustrated in accordance with examples of the present disclosure. The flow diagrams are illustrated merely as examples and are not meant to confine the present disclosure to any particular order or number of operations. The flow diagrams represent operations that may be performed by any of the computing devices illustrated in the preceding figures or those discussed as relevant to the present disclosure.

Referring to FIG. 5, the flow diagram may begin and proceed to 502 where the computing device may detect user interaction with an edge of the computing device. In various examples, the computing device may detect user interaction with the edge utilizing a sensor that may be disposed in various locations along the computing device. In one example, the sensor may be disposed along a backside of the computing device or positioned along a periphery of the backside in a frame-like manner. Other configurations are contemplated.

Once detected, the computing device may prevent any user interaction with content displayed within an area of the touch sensitive surface adjacent to the edge at 504. In various examples, the computing device may utilize a controller to prevent user interaction with content displayed via the touch screen. With user interaction within the area prevented, the method may then end.

Referring to FIG. 6, the flow diagram may be begin and proceed to 602 where the computing device may detect user interaction with a portion of the computing device. In one example, the computing device may detect that a user is holding the device via a sensor disposed along an edge of the computing device. The sensor may determine that at least one portion of a user's hand is disposed in a position such that an unintended user input is likely to be received via the touch screen of the device that substantially spans a surface of the computing device.

In response to the detection at 602, a controller of the computing device may prevent the unintended user interaction with the content by scaling the content displayed via the touch sensitive display to include a virtual border at 604. The virtual border may exclude user content and thereby prevent any interaction with content in that area. The virtual border may be disposed along one side of the computing device such that the content is compressed in one direction, either horizontally or vertically. In another example, the content may be scaled in multiple directions such that content distortion is minimized.

Once scaled, unintended user interaction may be minimized. The content may remain scaled, for example, until the sensor detects a lack of subsequent user interaction with the edge at 606. Detecting a lack of subsequent user interaction may indicate a user is no longer holding the computing device, for example that a user has placed the computing device on a table or other support. In response to detecting the lack of subsequent user interaction at 606, the controller may scale the content to remove any virtual border or scaling previously implemented to prevent unintended user interaction. Once scaled, the content may again substantially span a surface of the computing device. The flow diagram may then end.

Referring to FIG. 7, another flow diagram may begin and proceed to 702, where the computing device may detect user interaction with a portion of the computing device. In one example, the computing device may detect that a user is holding the device via a sensor disposed along an edge of the computing device. The sensor may determine that at least one portion of a user's hand is disposed in a position such that an unintended user input is likely to be received via the touch screen of the device that substantially spans a surface of the computing device.

In response to the detected user interaction, the computing device may determine whether the user interaction with the content is within a predefined area and in response to a positive determination, disregard the user interaction at 704. The predefined area may be an area determined based upon various characteristics such as an average size of a user's hand. Disregarding the user interaction may comprise the controller receiving the user input and not executing a command associated with the user interaction.

In another example, the controller may generate a semi-transparent overlay to display via the touch sensitive surface at 706. The semi-transparent overlay may convey a touch insensitive area corresponding to the predefined area in which the controller will disregard the user interaction. In various examples, the semi-transparent overlay may occur on one side of the content, may occur on multiple sides of the content, or may take on other shapes and varying sizes, such as a semi-circle having a size approximate to a user's thumb. The controller may again disregard any user interaction occurring within the semi-transparent overlay.

Once the sensor determines that the user is no longer making contact within the predefined area, for example through the detection of a lack of subsequent user interaction at 708, the computing device may enable interaction within the predefined area at 710. In this manner, a user may place the computing device on a table or stand, and subsequently interact with media displayed along an edge of the computing device. The method may then end.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. A computing device, comprising:
a touch screen substantially spanning a surface of the computing device;
a sensor coupled to the touch screen, wherein the sensor is independent of the touch screen and is to detect user contact with the computing device; and
a controller coupled to the sensor, wherein the controller is to respond to detection of the user contact and prevent an action associated with an unintended user input within a predetermined area of the touch screen.

2. The computing device of claim 1, wherein the controller is to scale content displayed via the touch screen to generate a virtual border to prevent the unintended user input, the virtual border including no content.

3. The computing device of claim 2, wherein the sensor is to detect a subsequent absence of the user contact with the computing device; and
wherein the controller is to scale the content to remove the virtual border in response to the detected subsequent absence of the user contact.

4. The computing device of claim 1, wherein the controller is to ignore the unintended user contact within the predetermined area of the edge of the touch screen.

5. The computing device of claim 1, wherein the controller is to generate a semi-transparent overlay to display via the touch screen, the semi-transparent overlay to cover media displayed via the touch screen and convey a touch insensitive area to a user.

6. The computing device of claim 5, wherein the semi-transparent overlay is displayed on all edges via the touch screen.

7. The computing device of claim 5, wherein the semi-transparent overlay is a semi-circle.

8. A method, comprising:
detecting, via an edge sensor of a computing device, user interaction with an edge of the computing device, wherein the edge is planar with a touch sensitive surface substantially covering a side of the computing device; and
preventing, via a controller of the computing device, an action based on user interaction with content displayed within an area of the touch sensitive surface adjacent to the edge.

9. The method of claim 8, wherein preventing the action based on the user interaction with the content comprises scaling, via the controller, the content displayed via the touch sensitive surface to include a virtual border, the virtual border excluding the content.

10. The method of claim 9, further comprising:
detecting, via the edge sensor, lack of subsequent user interaction with the edge; and
scaling, via the controller, the content to remove the virtual boarder.

11. The method of claim 8, wherein preventing the action based on the user interaction with the content comprises determining, via the controller, that the user interaction with the content is within a predefined area, and in response, disregarding the user interaction.

12. The method of claim 11, further comprising:
generating, via the controller, a semi-transparent overlay to display via the touch sensitive surface, wherein the semi-transparent overlay is to convey a touch insensitive area corresponding to the predefined area.

13. The method of claim 11, further comprising:
detecting, via the edge sensor, lack of subsequent user interaction with the edge; and
enabling, via the controller, user interaction with the content within the predefined area in response to detecting the lack of subsequent user interaction with the edge.

14. A non-transitory computer readable medium comprising a plurality of programming instructions, that if executed by a processor of a computing device, cause the computing device to:
determine that a user is holding the computing device via an edge sensor; and
prevent execution of an action based on user interaction with content displayed within a predefined area of a touch screen, wherein the touch screen substantially spans a side of the computing device.

15. The non-transitory computer readable medium of claim 14, wherein the plurality of programming instructions, if executed by the processor of the computing device, cause the computing device to:
determine that the user is no longer holding the computing device via the edge sensor; and
execute an action based on user interaction with content displayed within the predefined area of the touch screen.
